(19) United States
(12) Patent Application Publication
(10) Pub. No.: US 2011/0123642 A1
(43) Pub. Date: May 26, 2011

(54) H2O2-BASED AQUEOUS BIOCIDAL COMPOSITION, METHOD OF MANUFACTURE AND USE

(76) Inventor: Remi Wilmotte, Chalons Sur Vesle (FR)

(21) Appl. No.: 13/000,504

(22) PCT Filed: Jun. 23, 2009
(86) PCT No.: PCT/FR09/51196

§ 371 Date: Feb. 2, 2011

(30) Foreign Application Priority Data
Jun. 26, 2008 (FR) 0854301

(51) Int. Cl. A01N 59/00; A01P 1/00

(52) U.S. Cl. 424/616

(57) ABSTRACT

An aqueous oxidizing biocidal composition comprising hydrogen peroxide (H₂O₂), an RCO₂H/RCO₃H mixture where R is an aliphatic C₁-C₆ residue comprising a saturated or unsaturated, linear or branched hydrocarbon chain and a catalyst allowing the dismutation of the H₂O₂/RCO₂H/RCO₃H mixture, wherein the catalyst is complexed with glutamic acid-N,N-diacetic acid or a salt of same.

The invention relates to an aqueous biocidal composition containing hydrogen peroxide (H₂O₂) and an RCO₂H/RCO₃H carboxylic acid/carboxylic peracid mixture. It further relates to a method of manufacture of the aforesaid composition, and to its use in the field of disinfection, hygiene and/or pollution control, on the one hand, and in the field of surface treatment (in particular cleaning, scouring and/or passivation), on the other hand.

Disinfecting solutions containing the mixture H₂O₂/RCO₂H/RCO₃H have both an oxidizing power and a reduction power and can undergo a dismutation of hydrogen peroxide according to the following reaction: H₂O₂→O₂+H₂O. This thermodynamically possible reaction is slow (several days). This is why hydrogen peroxide is commercially available in stabilized form with phosphoric acid, pyrophosphates, pyridine carboxylic acids and Sn⁴⁺ salts. To accelerate the reaction kinetics, it is essential to catalyze the reaction. This catalysis is illustrated by the known Fenton reaction:

H₂O₂+Fe²⁺→OH⁻+Fe³⁺+OH (1)

In the presence of catalyst, the hydrogen peroxide dismutation reaction is instantaneous and its reduction leads to the formation of the hydroxyl ion, one of the most oxidizing states of oxygen.

The document U.S. Pat. No. 5,521,056 describes a bleaching composition used in the field of color photography. The composition contains essentially a peracid as well as a ternary complex made up of ferric ions, a polydentate ligand and a carboxylate ligand. Example 12 shows the limited effect on the improvement of bleaching rate of a composition containing hydrogen peroxide and a non-biodegradable EDTA/ferric nitrate complex from the viewpoint of the same composition further containing pyridinedicarboxylic acid constituting the ternary complex.

The document EP 1 175 149 B9 describes a disinfecting composition comprising, as a catalyst, transition metal ions with their various valences. The compositions described contain agents that stabilize hydrogen peroxide thus limiting the slow degradation of H₂O₂ in contact with calcium ions of water. The stabilizing agents used are either phosphoric acid or pyridine carboxylic acid, according to the nature of the metal ion. These stabilizing agents effectively guarantee the harmful effects of calcium of water on H₂O₂ but do not avoid the dismutation of H₂O₂ caused by the presence of metal ions. Thus, this implies that, as soon as the H₂O₂/RCO₂H/RCO₃H mixture is in contact with one of the elements cited (in ionized form) there is decomposition of the mixture and production of oxygenated free radicals. In other words, it is impossible to preserve disinfecting solutions and solutions can be used only after extemporaneous mixing with catalysts, which makes their use extremely complex and their transport difficult. It is what the examples of the embodiments disclosed in this document confirm showing the better disinfecting effect of compositions containing Ag²⁺, MoO₄²⁻, VO₃⁻, VO₂⁺, V⁵⁺ and WO₄² ions, from the viewpoint of compositions of the prior art containing Ag⁺, the compositions being tested immediately after manufacture.

In other words, the problem that the invention proposes to solve is to develop biocidal and biodegradable solutions, containing an H₂O₂/RCO₂H/RCO₃H mixture and catalyst, that are stable over time, that is to say, that do not lead to dismutation of hydrogen peroxide when the solution is stored at a pH between 1 and 8.5.

To this end, the Applicant developed solutions in which metal ions are complexed with a specific ligand in a stable manner in a wide range of pH (between 1 and 8.5) according to the choice of catalyst, the release of ions and thus catalysis of the dismutation reaction of the mixture starts only after destruction or modification of the complexes formed, by dilution of the composition and/or variation of pH, determined according to the final use.

More precisely, the invention relates to an aqueous oxidizing biocidal composition comprising stabilized or non-stabilized hydrogen peroxide (H₂O₂), an RCO₂H/RCO₃H mixture where R is an aliphatic C₁-C₆ residue containing a saturated or unsaturated, linear or branched hydrocarbon chain and a catalyst allowing the dismutation of the H₂O₂/RCO₂H/RCO₃H mixture.

The composition is characterized in that the catalyst is complexed with at least one ligand, advantageously only one ligand, in the species glutamic acid-N,N-diacetic acid or a salt of same.

In practice, the pKa of the ligand has the highest possible value, in practice higher than 7, advantageously higher than 9.

In other words, the invention consists in having developed a composition whose disinfecting effect is released only at the time of use, by dilution and/or variation of pH. Indeed, generally, for problems related to explosion risk, the aqueous composition of the invention contains a content of H₂O₂ that is less than or equal to 60% by weight compared to the weight of the aforesaid composition, advantageously roughly 30% by weight. Thus, the composition is likely to be diluted at the time of use, according to the applications envisaged as will be seen below.

The dilution operation leads to a variation of the pKa of the ligand/catalyst pair and a variation of the redox potential and thus the creation of a series of complexes characterized by successive dissociation constants of decreasing value. The complexes formed are modified by dilution according to Ostwald's law, thus releasing the catalyst at increasing degrees of oxidation according to the value of the pH of the solution and the nature of the aforesaid catalyst. For a given catalyst, release of the catalyst thus initiates dismutation of the H₂O₂/RCO₂H/RCO₃H mixture in a specific range of pH.

The dissociation constant of the ligand/catalyst pair (pKd) at the time of storage thus must be the highest possible. In practice, the pKd of the ligand/catalyst pair depends in most cases on the pKa/pH relationship. According to the invention, the dissociation effect of pH is reduced by adding an excess of ligand.

In a continuous manner, the pH of the composition before use, that is to say, during storage, in practice, is between 1 and 8.5, advantageously between 1 and 6. Indeed, it is perfectly known that beyond pH 8.5, that is to say, at alkaline pH, the mixture of hydrogen peroxide and acetic acid is unstable and breaks down immediately.

Furthermore, the higher the redox potential of the composition the more effective is the disinfecting effect. The objective of the invention is thus to reduce as much as possible the H₂O₂/RCO₂H/RCO₃H mixture at the moment of use, to obtain the highest possible degree of oxidation of oxygen. According to the invention, the oxidation-reduction potential of the catalyst is advantageously between ±0.69 V, corresponding to the value of the redox potential of the O₂/H₂O₂ pair, and ±2.10 V, corresponding to the value of the redox potential of the H₂O₂—RCO₂H—RCO₃H/H₂O pair. Generally, insofar as the redox potential of the complexes formed varies proportionally with the stability of the ligand/ion complex, it is possible to preferentially stabilize an ion with a preferred valence according to the ligand/ion domain of predominance.

To this end, the catalyst is either a transition metal and/or alkaline-earth from a source L providing the aforementioned ions, or an essential oil.

When it is a transition metal and/or alkaline-earth, the ions from source L are selected from the group comprising Ag³⁺, Mn⁴⁺, Ag⁺, Ag²⁺, V⁴⁺, Cr³⁺, Fe³⁺, Fe²⁺, Au⁺, Cu⁺, Cu²⁺, Pd²⁺, Pt²⁺, Mn²⁺, Au³⁺, Mn³⁺, Co²⁺, Ni²⁺, Mo³⁺, Mo⁶⁺ and Mg²⁺. Of course, the ions can be used alone or in mixture. Source L is provided either as a salt in which the transition metal is at its maximum degree of oxidation, or as a metal oxide, if the oxide is soluble in acids.

In a preferred embodiment, the complexed ions are: iron and/or molybdenum and/or silver and/or cobalt and/or copper.

The positively charged ions are adsorbed by the cell membrane of negatively charged bacteria thus rendering the membrane permeable: lipopolysaccharides are eliminated from the membrane of Gram-negative bacteria. They then react on the sulfhydryl functions of enzymes leading to the formation of metal sulfides. Chelate ligands in excess with respect to metal ions potentiate these actions.

Complexes containing molybdenum are particularly interesting because molybdenum plays a large role in the natural cycle of nitrogenase and pteridines. It can be used alone or in combination with the other metals cited thus enabling a greater diversity of formulation according to the targets to be reached. Complexes formed with Mo make it possible to catalyze oxidation reactions up to a pH of 8.5. Moreover, in the amounts used, molybdenum is not toxic. Furthermore, and above all, the Applicant noted that the presence of molybdenum, once released, led to the production of the most oxidizing species of oxygen, namely singlet oxygen ¹O₂. This embodiment is more particularly described in the examples.

When the catalyst is an essential oil, said oil is advantageously selected from the group comprising, from the highest redox potential to lowest redox potential, rosemary>lavender luisleri>everlasting>cinnamon bark>α sage>thujone>lemon limo>clove>oregano carva>savory>montana>thyme thymol>oregano. As an example, essential oils of rosemary containing oxidized terpene compounds have a high redox potential making it possible to generate at a given pH dismutation of the H₂O₂/RCO₂H/RCO₃H mixture. Moreover, as the α-pinene content oxidizes easily in ketonic acid (pinonic acid), catalysis at pH near 4 will become effective. The redox potential of these essential oils was particularly studied by Professor Claude Vincent (Bioelectronics treatise, Marco Dutteur publishing, 1996).

According to the invention, the essential oils are advantageously used in emulsified form in an anionic surfactant.

According to an essential characteristic of the invention, the chelating agent is glutamic acid diacetic acid and salts of same. Advantageously the chelating agent is GLDA: L-glutamic acid-N,N-diacetic acid, tetrasodium salt corresponding to CAS No. 51 981-21-6 and with the following formula:

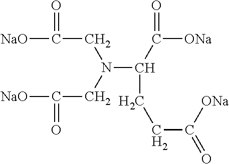

This ligand has the advantage of being biodegradable and moreover has a certain bactericidal activity on Gram-positive and Gram-negative bacteria. Furthermore, it has a stability equivalent to that of EDTA and NTA: GLDA pKa=9.4; NTA pKa=9.7; EDTA pKa=10.2 in a very wide range of pH. All of the ions mentioned previously can be complexed by being salted out at the moment of dismutation, in precise ranges of pH and at given dilutions making it possible to prepare disinfecting solutions that are very stable over time. GLDA pKa characteristics are as follows: pKa¹ : 9.4; pKa²: 5.0; pKa³: 3.5; pKa⁴: 2.6. Each complex formed between the GLDA ligand and a transition metal or magnesium has its own range of stability according to pH, from pH 1 to pH 13.

Advantageously, the catalyst/ligand complex is Mo/GLDA complex.

The ligand/catalyst ratio will be determined according to the desired release kinetics of the catalyst. Thus, the ligand will be in excess compared to the catalyst if it is desired to delay release of the catalyst in its most oxidized form until a later dilution.

In practice, the catalyst/ligand complex has a concentration between 1×10⁻⁴ g/l and 50×10⁻² g/l.

Next, in terms of acetic acid, taking into account the equilibrium reaction:

H₂O₂+RCO₂H<=>H₂O+RCO₃H

the respective quantities of RCO₃H and RCO₂H in the RCO₃H/RCO₂H mixture are not critical. It suffices to have in contact in H₂O either H₂O₂ and RCO₃H or H₂O₂ and RCO₂H to obtain a ternary H₂O₂+RCO₃H+RCO₂H mixture since H₂O₂ is in excess compared to the RCO₂H/RCO₃H pair. It also suffices to some extent to incorporate:
(i) RCO₂H in the presence of H₂O₂, or
(ii) RCO₃H (which in concentrated state generally contains H₂O₂ and RCO₂H),
   in H₂O, to obtain at equilibrium the group H₂O₂+RCO₃H+RCO₂H.

As indicated above, the R pair of the acid/peracid pair represents an aliphatic C₁-C₆ residue containing a saturated or unsaturated, linear or branched hydrocarbon chain. Advantageously, an R group containing a saturated linear hydrocarbon chain such as CH₃, CH₃CH₂ or CH₃(CH₂)₄ or an R group containing an unsaturated linear hydrocarbon chain such as notably CH₃—CH═CH, CH₃—CH═CH—CH₂ or CH₃—CH═CH—CH═CH will be used. The preferred R groups are (in order of increasing preference): CH₃—CH═CH—CH═CH, CH₃CH₂ or CH₃. Generally, the CH₃CO₂H/CH₃CO₂H pair (i.e. R=methyl) is preferred over the CH₃CH₂CO₂H/CH₃CH₂CO₃H pair (i.e. R=ethyl) since the first pair is more active than the second as a means of disinfecting/cleansing in the aqueous composition of the invention. Advantageously, in the aqueous composition of the invention, the B/A weight ratio of the RCO₂H/RRCO₃H mixture to hydrogen peroxide will be between 0.15/1 and 0.85/1. Preferably, this weight ratio will be between 0.5/1 and 0.7/1.

Furthermore, the aqueous solution is advantageously comprised of demineralized water (conductivity ≦10 μS).

To have a composition that can be used in various fields, it is necessary to adapt the wettability of the solutions to the problems encountered by incorporating in the composition at least one wetting agent. On the surface of a liquid, forces are directed to the middle of the liquid so that the free surface tends towards a minimum. Surfactants have as a fundamental property to adsorb themselves on the surface to the interfaces of opposing bodies. Their concentration will thus be higher on these favored sites than within the solution. From this, results two types of effects that can intervene separately or simultaneously:
reduction of one or more bonding strengths at the interfaces of the system considered (for example water-oil, oil-metal or metal-water),
adsorption at the interfaces with interface stabilization.

These two factors lead to a lowering of surface tension compared to the liquid medium.

The properties of surfactants being determined by their amphiphilic structure, their choice as additive will depend on both their behavior in the highly oxidizing solution of the invention and the surface properties of the materials, in the broad sense of the term, on which the solution is applied. According to the invention, the composition contains anionic, non-ionic or amphoteric surfactants, in most cases for approved use with food. For all applications related to disinfection or sterilization, the surfactants used are advantageously biodegradable.

In the case of adding essential oil as catalyst, the surfactants used have moreover emulsifying properties.

Advantageously, the wetting agent is 30 times ethoxylated glycerol ricinoleate.

In practice, the weight ratio of the wetting agent to hydrogen peroxide is advantageously between 0.00005/1 and 0.01/1. Practically speaking, this weight ratio will be even more advantageously roughly 0.005/1.

Specific products that play the role of corrosion inhibitor can also be added to the solution: these products settle directly or in the form of various compounds on the surface of the metal, which is thus protected against the corrosive action of the medium. The two essential mechanisms of this protection are passivation and adsorption. Many corrosion inhibitors can be used without the list being exhaustive. Most act by steric inhibition, limiting the contact surface between the solution and the metal to be protected. Inhibitors that can be used include oxidized or non-oxidized polyamines, dicyclohexylamine nitrite, benzotriazole, organophosphates, etc.

When it is sought to destroy biofilms more particularly, the composition of the invention contains, as preferred corrosion inhibitor, DMAD, a corrosion inhibitor containing long-chain unsaturated fatty acid dimethylamides sold by BUCKMAN. This inhibitor can be used in all closed circuits such as cooling towers at a concentration of 50 ppm to 300 ppm according to the types of corrosion and biofilms encountered.

The composition can further contain fragrances, such as for example essential oils or nitrile-based synthetic essences, whose redox potentials are in harmony with the base composition to mask, if need be, the odor of acetic acid.

The invention also relates to a method of manufacture of the composition previously described wherein:
acid RCO₂H is slowly introduced into a stabilized or not stabilized aqueous H₂O₂ solution in excess,
the resulting solution obtained is allowed to rest until H₂O₂+RCO₂H<=>H₂O+RCO₃H equilibrium is established,
the catalyst/ligand mixture (GLDA) is prepared separately and then introduced into the H₂O₂/RCO₂H/RCO₃H solution,
pH is adjusted so that the complexed catalyst remains in the range of stability of the catalyst/ligand complex characterized by its pKa,
the solution is made up with demineralized water to reach the desired H₂O₂ concentration of the composition.

According to the method, the stabilized or not stabilized H₂O₂ has a concentration below 60%. Furthermore, the mixture with acid RCO₂H is prepared slowly, under non-turbulent stirring, at a concentration outside the range of explosiveness of the mixture. If necessary, the mixture is cooled. The equilibrium reaction is reached when the redox potential is stabilized, this potential being a function of the H₂O₂/RCO₂H ratio, knowing that the ratio of RCO₂H/RCO₃H to hydrogen peroxide is generally between 0.5/1 and 0.85/1, this ratio being a function of the nature of the bacterial strains to destroy.

According to another characteristic, when the catalyst is provided as a transition metal or alkaline-earth ion, the complexing solution is prepared starting from a source L that releases ions selected from the group comprising Ag³⁺, Mn⁴⁺, Ag⁺, Ag²⁺, V⁴⁺, Cr³+, Fe³⁺, Fe²⁺, Au⁺, Cu⁺, Cu²⁺, Pd²⁺, Pt²⁺, Mn²⁺, Au³⁺, Mn³⁺, Co²⁺, Ni²⁺, Mo³⁺, Mo⁶⁺ and Mg²⁺, alone or in mixture. In practice, the catalyst+ligand solution is introduced so that the concentration compared to the H₂O₂/RCO₂H/RCO₃H mixture of the complexed catalyst is between 1×10⁻⁴ g/l and 50×10⁻² g/l.

The uses of the oxidizing aqueous composition of the invention notably include disinfection of water to make it drinkable; hygiene of industrial sites and swimming pools; cold sterilization of surgical and dental instruments; protection of plants and harvests from bacteria, molds, viruses and parasites; protection of fish, seafood and shellfish from pathogenic algae such as Euglena; pollution control at mining sites; and those sites treated by cleaning, scouring and/or passivation of metal surfaces (notably steel or aluminum surfaces) or non-metal surfaces (notably plastic or ceramic surfaces, plastic surfaces comprising herein those of exposed floor or wall coverings generally made of PVC, polyacrylate, polycarbonate or other). Advantageously, the composition intended for disinfection and hygiene will be obtained by dilution of a standard composition so as to have an H₂O₂ concentration of 1% to 2% by weight.

Also advantageously, the composition intended for pollution control at mining sites will have an H₂O₂ content of 4% to 7.9% by weight and will be diluted at the moment of use to a final concentration less than or equal to 1/100 (i.e. a final H₂O₂ content less than or equal to 0.04% by weight). In the field of surface treatment, the composition will advantageously have an H₂O₂ content between 1% and 7.9% by weight and will have a C/D weight ratio lower than 1/1 and higher than 1/2.

In fact, the composition of the invention can be incorporated into a solution or another more complex form used for the applications envisaged above. As an example, the composition of the invention can be incorporated into a hand gel. The same composition can be incorporated into a disinfecting solution for industrial sites. The advantage of the invention is the development of a single disinfecting core that can be formulated for various applications.

The invention and resulting advantages can be clearly seen in the examples which follow.

### Preparation of the Composition

The recommended general method comprises the following steps:

in a 316 L passivated stainless steel tank, introduce stabilized H₂O₂ at a concentration below 60%;

1—slowly introduce, under non-turbulent stirring, acid RCO₂H at a concentration outside the range of explosiveness of the mixture; cool if necessary;

2—wait until the equilibrium reaction ends;

3—prepare the complexing solution from a source of one of the cited metals by adding to it an excess of ligand compared to the catalyst;

4—introduce the complexed ligand+cation solution so that the concentration of the complexed cation compared to the H₂O₂/RCO₂H/RCO₃H mixture is between 1×10⁻⁴ g/l and 20×10⁻³ g/l;

5—adjust the pH so that the complexed cation remains in the stability range of the complex;

6—make up the solution with demineralized water to reach the desired concentration of the preparation.

### EXAMPLE 1

### Preparation When the Source (S) Releases Fe²⁺

(a) Prepare a stock solution according to the preceding method so as to obtain at equilibrium a solution containing:

i. H₂O₂: 300 g/l

ii. CH₃COOH: 80 g/l

iii. CH₃COOOH: 5 g/l

The pH of the resulting solution is ≦2.5.

(b) Preparation of the complexed solution containing Fe²⁺:
dissolve 20 g FeSO₄, 7H₂O in 1000 ml demineralized water;
complex Fe²⁺ with 1.5 times the required quantity of GLDA.

(c) Introduce 1 ml of the complexed solution into the stock solution;

(d) bring up to 1 liter with demineralized water.

No dismutation reaction is noted after mixing.

To eliminate Legionella from a cooling tower (Legionella concentration observed to be 10⁵ whereas the allowed concentration is 10³), after descaling in phosphoric acid medium the pH of the cooling tower water is 6.

3 ml/m³ of the solution obtained in (d) is injected via feed pump into the feed circuit of the cooling tower. Fe²⁺ is released from its complex with GLDA by dilution and increase in pH; there is dismutation of H₂O₂ and CH₃COOOH under the action of the Fe²⁺ catalyst and formation of the hydroxyl ion OH⁻, highly oxidant, which will destroy Legionella.

After 2 hours of contact with the disinfecting solution, the concentration of Legionella fell to 10², lower than the allowed quantity of 10³.

### EXAMPLE 2

### Preparation When the Source (S) Releases Mo⁶⁺ and Mo³⁺

(a) Prepare a stock solution according to the preceding method so as to obtain at equilibrium a solution containing:

iv. H₂O₂: 280 g/l

v. CH₃COOH: 80 g/l

vi. CH₃COOOH: 3 g/l

The pH of the resulting solution is adjusted to 5.

(b) Preparation of the complexed solution containing Mo:
dissolve 20 g molybdic acid in 700 ml demineralized water;
complex the Mo with 2 times the required quantity of GLDA ligand;
bring up to 1000 ml with demineralized water.

(c) Introduce 2 ml of the complexed solution into the stock solution.

The resulting solution is stable for 1 year.

The effectiveness of this disinfecting solution is verified by fogging according to standard NFT 72-281 on the following strains:
Pseudomonas aeruginosa
Staphylococcus aureus
Streptococcus faecium
Bacillus subtilis
Candida albicans
Penicillium verrucosum var. cyclopium
   strains to which is added Acinetobacter baumanii, which is resistant to many antibiotics.

The standard imposes a bacterial log reduction of 10⁵.

After tests, it is noted that a bacterial log reduction of 10⁸ is obtained with a resulting solution diluted to 300/1 and a contact time of only 10 minutes (the standard imposes a contact time less than 12 hours).

Such results cannot be obtained with oxidation by the hydroxyl ion OH. Study of the solution during the reaction showed that there was production of the most oxidizing species of oxygen: singlet oxygen ¹O₂ (this species was detected by HPLC and by its own luminescence in the infrared range at 1268 nm).

Singlet oxygen was formed during the following reactions catalyzed by the MoO₄²⁻ species released from the Mo/GLDA complex by dilution according to Ostwald's law:

CH₃COOOH+H₂O₂→CH₃COOH+H₂O+¹O₂⁻+³O₂

(¹O₂⁻: highly oxidant singlet oxygen; ³O₂: triplet oxygen or weakly oxidizing oxygen molecule)

2H₂O₂→2H₂O+1O₂⁻

These oxidation reactions occur only if the reactions are catalyzed by certain transition metals to their maximum degree of oxidation.

### EXAMPLE 3

### Preparation When the Source (S) Releases V⁵⁺

(a) Preparation of the stock solution

i. H₂O₂: 300 g/l

introduce slowly, 100 ml per minute

ii. CH₃COOH: 80 g/l

After the equilibrium reaction (24 h at 30° C. or 8 days at 20° C.) there is formation of

iii. CH₃COOOH: 5 g/l

The pH of the resulting solution is 2.5.

(b) Preparation of the complexed solution containing V⁵⁺
dissolve 35.72 g of V₂O₅ (which is 10 g of V) in 1000 ml demineralized water
bring up the V⁵⁺ with 112 g GLDA (an excess of GLGA is necessary for the stability of the complex)

(c) Introduce 5 ml of the complexed solution into the stock solution;

(d) bring up to 1 liter with demineralized water;

(e) bring the pH to 3.

No dismutation reaction is noted after mixing; observed stability is longer than one year.

To eliminate Legionella from a cooling tower (Legionella concentration observed to be 10⁵ whereas the allowed concentration is 10³), after descaling in phosphoric acid medium the pH of the cooling tower water is 6.

3 ml/m³ of the solution obtained in (d) is injected via feed pump into the feed circuit of the cooling tower. V⁵⁺ is released from its complex with GLDA by dilution and increase in pH; there is dismutation of H₂O₂ and CH₃COOOH under the action of the V⁵⁺ catalyst and formation of singlet oxygen (the most reactive of oxidants), which will destroy Legionella. After 2 hours of contact with the disinfecting solution, the concentration of Legionella fell to 10, lower than the allowed quantity of 10³.

1. An aqueous oxidizing biocidal composition comprising hydrogen peroxide (H₂O₂), an RCO₂H/RCO₃H mixture where R is an aliphatic C₁-C₆ residue comprising a saturated or unsaturated, linear or branched hydrocarbon chain and a catalyst allowing the dismutation of the H₂O₂/RCO₂H/RCO₃H mixture, wherein the catalyst is complexed with glutamic acid-N,N-diacetic acid or a salt of same.

2. The composition of claim 1, wherein the pKa of the ligand is greater than 7.

3. The composition of claim 1, wherein the oxidation-reduction potential of the catalyst is from ±0.69 V, corresponding to the value of the redox potential of the O₂/H₂O₂ pair, to ±2.10 V, corresponding to the value of the redox potential of the H₂O₂—RCO₂H—RCO₃H/H₂O pair.

4. The composition of claim 1, wherein the catalyst is a transition metal or alkaline-earth from a source providing ions selected from the group consisting of Ag³⁺, Mn⁴⁺, Ag⁺, Ag²⁺, V⁴⁺, Cr³⁺, Fe³⁺, Fe²⁺, Au⁺, Cu⁺, Cu²⁺, Pd²⁺, Pt²⁺, Mn²⁺, Au³⁺, Mn³⁺, Co²⁺, Ni²⁺, Mo³⁺, Mo⁶⁺ and Mg²⁺, alone and mixtures thereof.

5. The composition of claim 4, wherein the catalyst is a transition metal from a source providing ions selected from the group consisting of iron, molybdenum, silver, cobalt, copper and mixtures thereof.

6. The composition of claim 1, wherein said composition comprises a Mo/GLDA complex as catalyst/ligand complex.

7. The composition of claim 1, wherein the catalyst is an essential oil selected from the group consisting of rosemary, lavender luisleri, everlasting, cinnamon bark, α sage, thujone, lemon limo, clove, oregano carva, savory, montana, thyme, thymol and oregano.

8. The composition of claim 1, wherein the ligand is GLDA: L-glutamic acid-N,N-diacetic acid, tetrasodium salt.

9. The composition of claim 1, wherein said composition further comprises 30 times ethoxylated glycerol ricinoleate as wetting agent.

10. A method of manufacture of the composition of claim 1 comprising:
slowly introducing acid RCO₂H into a stabilized or not stabilized aqueous H₂O₂ solution in excess,
allowing a resulting solution obtained to rest until H₂O₂+RCO₂H<=>H₂O+RCO₃H equilibrium is established,
separately preparing a catalyst/ligand mixture (GLDA) and then introducing said mixture into the H₂O₂/RCO₂H/RCO₃H solution,
adjusting pH so that complexed catalyst remains in the range of stability of catalyst/ligand complex characterized by pKa thereof,
wherein the solution is made up with demineralized water to reach the desired H₂O₂ concentration of the composition.

11. The method of claim 10, wherein the catalyst+ligand solution is added so that the concentration of the complexed catalyst compared to the H₂O₂/RCO₂H/RCO₃H mixture is from 1×10⁻⁴ g/l to 50×10⁻² g/l.
